(19) United States
(12) Patent Application Publication
(10) Pub. No.: US 2026/0342149 A1
(43) Pub. Date: Oct. 29, 2026

(54) Stator Device for an Electric Machine Designed to Drive a Motor Vehicle, Electric Machine for a Motor Vehicle, and Motor Vehicle Having an Electric Machine

(71) Applicant: Bayerische Motoren Werke Aktiengesellschaft, Muenchen (DE)

(72) Inventor: Martin OBERMUELLER, Linz (AT)

(21) Appl. No.: 19/120,421

(22) PCT Filed: Nov. 21, 2023
(86) PCT No.: PCT/EP2023/082464

§ 371 Date: Apr. 11, 2025

(30) Foreign Application Priority Data
Dec. 13, 2022 (DE) 10 2022 133 065.6

(51) Int. Cl. H02K 1/20; H02K 3/24

(52) U.S. Cl. CPC H02K 1/20; H02K 3/24

(57) ABSTRACT

A stator device for an electric machine includes stator laminations arranged in a row in the direction of longitudinal extent of the stator device that together form a stator laminated core, and through which a fluid channel arrangement extends in the direction of longitudinal extent and being designed, in order to cool winding heads of the electric machine, to guide fluid in the direction of the winding heads. The stator device has at least one nozzle element coupled fluidically to the fluid channel arrangement on at least one stator laminated core end of the stator laminated core and that has at least one nozzle opening that is shaped so as to form a fluid jet for cooling at least one of the winding heads.

### BACKGROUND AND SUMMARY

The invention relates to a stator device for an electric machine designed to drive a motor vehicle. Further aspects of the invention relate to an electric machine for a motor vehicle and to a motor vehicle having an electric machine.

Stator devices of this type usually have a plurality of stator laminations juxtaposed in the direction of longitudinal extent of the stator device and thus lying against one another as it were in a row.

EP3977597A1 discloses an electric machine having a stator with a lamination stack and with windings, wherein, at axial ends of the lamination stack, a respective winding head, formed from the windings, projects from the lamination stack in the axial direction. The electric machine comprises a rotor which is rotatably mounted in the stator. The rotor comprises a rotor body and a shaft on which the rotor body is fastened. A cooling device serves to cool the electric machine by a coolant. The cooling device is configured to convey the coolant from the shaft in the direction of the winding heads and thus to cool the winding heads.

An object of the present invention is to provide a stator device of the type mentioned at the beginning which contributes to effective cooling of an electric machine. In addition, an object of the invention is to provide an electric machine having such a stator device, and a motor vehicle having an electric machine.

This object is achieved by a stator device, by an electric machine, and by a motor vehicle having the features disclosed herein. Advantageous embodiments with expedient developments of the invention are also specified in the present disclosure.

A first aspect of the invention relates to a stator device for an electric machine designed to drive a motor vehicle, comprising a plurality of stator laminations juxtaposed in the direction of longitudinal extent of the stator device, which together a stator lamination stack, and through which extends in the direction of longitudinal extent a fluid duct assembly which, in order to cool winding heads of the electric machine, is designed to guide fluid in the direction of the winding heads.

According to the invention, it is provided that the stator device has at least one nozzle element which is fluidically coupled to the fluid duct assembly at at least one stator lamination stack end of the stator lamination stack and which has at least one nozzle opening shaped so as to form a fluid jet for cooling at least one of the winding heads. The fluid jet can preferably take the form of an oil jet and thus in other words oil can be guided as the fluid through the stator device and be used to cool the at least one winding head. The nozzle element allows an increased degree of design freedom and the simple production of the fluid duct assembly, for example by separating processes such as punching. The directed guidance of the fluid in the direction of the at least one winding head can take place through the nozzle element.

The invention is based on the insight that the targeted application of a fluid, in particular oil, to winding heads of an electric machine contributes to particularly effective cooling. The at least one nozzle element can thus effect targeted guidance of the fluid at the stator lamination stack end for the purpose of cooling the winding head, wherein the fluid jet can be oriented in a targeted fashion in the direction of the winding head with the aid of the nozzle element generally at an end side of the stator lamination stack.

In an advantageous development of the invention, the fluid duct assembly has at least one collection duct assembly by which fluid can be guided from a plurality of fluid ducts, arranged next to one another in the circumferential direction of the stator lamination stack, of the fluid duct assembly to at least one supply duct of the fluid duct assembly, into which supply duct the at least one nozzle element is introduced. As a result, the fluid from the plurality of fluid ducts arranged next to one another in the circumferential direction of the stator lamination stack can be merged in a particularly targeted fashion and consequently a large amount of the fluid can be conveyed to the at least one winding head.

A particularly advantageous embodiment is obtained by the following variant: the fluid duct assembly can have longitudinally extending fluid ducts, for example first longitudinally extending fluid ducts and second longitudinally extending fluid ducts which are different from each other and can be formed by respective through openings in the individual stator laminations arranged one behind the other. The longitudinally extending fluid ducts can open into radially extending fluid ducts which can extend in the direction of radial extent of the stator device. It is conceivable that a plurality of first longitudinally extending fluid ducts of the fluid duct assembly which can correspond to the fluid ducts arranged next to one another in the circumferential direction are coupled to a second longitudinally extending fluid duct of the fluid duct assembly by respective radially extending fluid ducts which are oriented outward in the direction of radial extent, converge with one another, in particular converge with one another in an arrow shape, are connected to one another, and can be associated with the collection duct assembly. The second longitudinally extending fluid duct can correspond to the supply duct and can guide the fluid in the direction of the stator lamination stack end. The at least one nozzle element can be introduced into a region of the second longitudinally extending fluid duct (supply duct). In order to fix the nozzle element in the fluid duct assembly, for example in the second longitudinally extending fluid duct, simply and captively, the nozzle element can be adhesively bonded or press-fitted, for example, into the fluid duct assembly.

In a further advantageous development of the invention, the fluid ducts arranged next to one another are arranged further toward the inside in the direction of radial extent of the stator device than the at least one supply duct. As a result, improved cooling can advantageously be obtained, for example in the region of respective stator teeth.

In a further advantageous development of the invention, the at least one nozzle element has a nozzle element duct region which traverses a plurality of the stator laminations and via which a nozzle element end region, connected to the nozzle element duct region, of the at least one nozzle element can be supplied with fluid from the fluid duct assembly. Because the nozzle element duct region traverses a plurality of the stack laminations, the nozzle element duct region can be introduced into a region of the stator lamination stack. This allows a particularly durable connection between the at least one nozzle element and the stator lamination stack. The nozzle element duct region can, for example, be molded onto a region of the fluid duct assembly, i.e. can form a form fit with at least a region of the fluid duct assembly.

In a further advantageous development of the invention, the nozzle element end region is arranged outside the stator lamination stack. As a result, the nozzle element end region can project from the stator lamination stack and be supported at the end side on an outermost stator lamination of the stator lamination stack. This allows, for example, simplified orientation when mounting the nozzle element.

In a further advantageous development of the invention, the nozzle opening is arranged at the nozzle element end region and fluidically connected to the nozzle element duct region. As a result, propagation of the fluid jet is hindered to a lesser degree by spatial conditions and a significant deflection of the fluid jet is permitted with the aid of the nozzle element end region where necessary. This advantageously allows the fluid jet to be oriented in a particularly needs-based fashion.

In a further advantageous development of the invention, respective center axes of the nozzle opening and of the nozzle element duct region enclose an angle between them. As a result, the fluid jet can exit the nozzle opening at the corresponding angle and be aimed so as to strike the winding head to be cooled.

In a further advantageous development of the invention, at least a region of the nozzle element end region has a hemispherical form. This allows, on the one hand, the nozzle element end region to lie uniformly on the stator lamination stack and, on the other hand, the fluid jet to be oriented flexibly.

A second aspect of the invention relates to an electric machine for a motor vehicle with at least one stator device according to the first aspect of the invention. The electric machine can in particular take the form of a drive machine of the motor vehicle. Such an electric machine can be cooled particularly effectively.

A third aspect of the invention relates to a motor vehicle having at least one electric machine according to the first aspect of the invention.

The preferred embodiments presented with reference to one of the aspects and their advantages apply correspondingly to the respective other aspects of the invention, and vice versa.

The features and combinations of features mentioned above in the description, as well as the features and combinations of features mentioned below in the description of the Figures and/or shown only in the Figures can be used not only in the combination specified in each case but also in other combinations or in isolation without going beyond the scope of the invention.

Further advantages, features, and details of the invention can be found in the claims, the following description of preferred embodiments, and the drawings.

The invention is explained again below on the basis of a specific exemplary embodiment.

### BRIEF DESCRIPTION OF THE DRAWINGS

FIG. 1 shows a schematic illustration of a motor vehicle with a likewise schematically illustrated electric machine which comprises a stator device shown in section;

FIG. 2 shows a schematic perspective view of the stator device which shows a plurality of through openings which each form a part of respective fluid ducts, arranged next to one another, as first longitudinally extending fluid ducts, as well as radially extending fluid ducts which are connected to one another and are associated with a collection duct assembly;

FIG. 3 shows a detailed view of a nozzle element of the stator device; and

FIG. 4 shows a perspective illustration in section of the nozzle element shown in FIG. 3 through the nozzle element end region of which a nozzle opening extends.

### DETAILED DESCRIPTION OF THE DRAWINGS

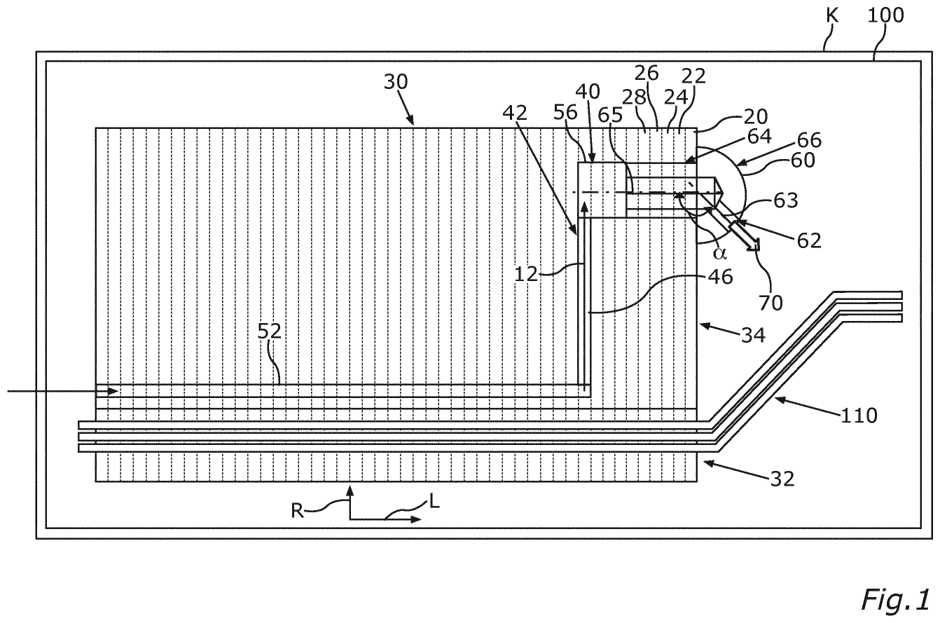

FIG. 1 shows in an abstract illustration a motor vehicle K which has an electric machine 100. The electric machine 100 serves in the present case to drive the motor vehicle K, i.e. as an electric drive machine. The electric machine 100 has a stator device 10 shown in FIG. 1 in a schematic illustration in section. Further components of the electric machine 100, such as for example a rotor, are not illustrated further in the present case.

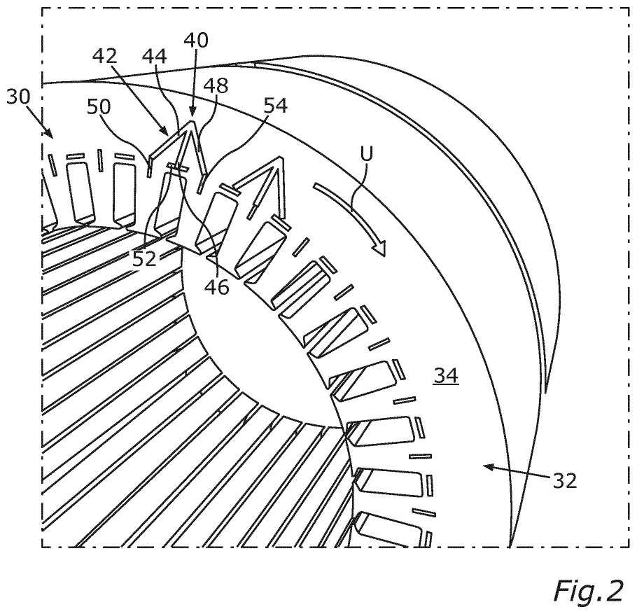

The stator device 10 comprises a plurality of stator laminations 20, 22, 24, 26, 28 which are juxtaposed in the direction of longitudinal extent L of the stator device 100, together form a stator lamination stack 30, and through which a fluid duct assembly 40 extends in the direction of longitudinal extent L and in the direction of radial extent R of the stator device 100, said fluid duct assembly being designed, for the purpose of cooling winding heads 110 of the electric machine 100, to guide fluid 12 in the form of oil in the direction of the winding heads 110. The direction of longitudinal extent L and the direction of radial extent R are illustrated in FIG. 1 by respective arrows. A circumferential direction U of the stator device 100 is in the present case illustrated in FIG. 2 by a curved arrow.

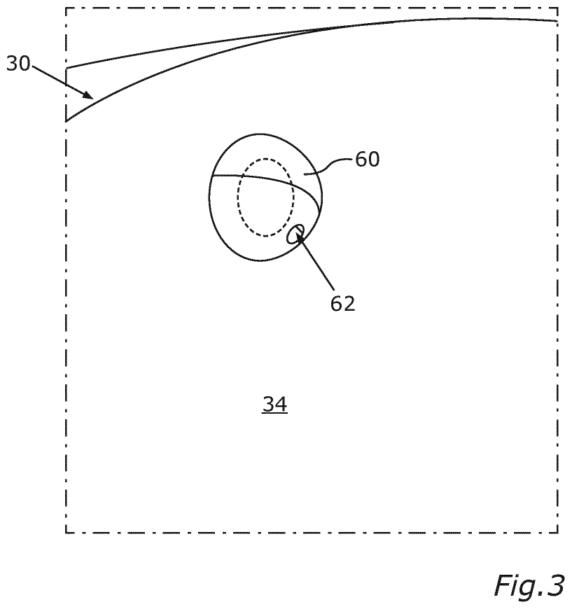

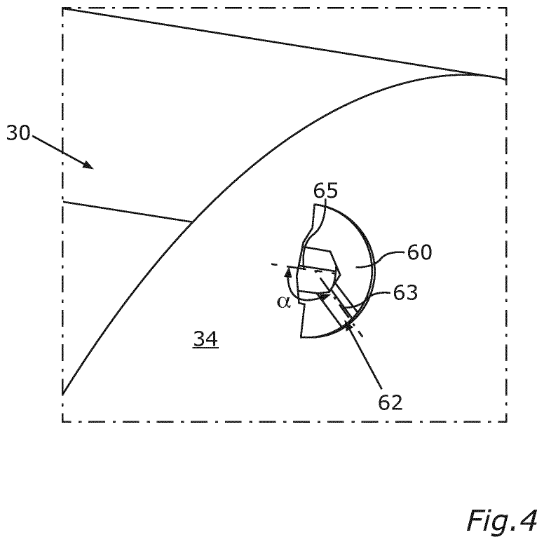

The stator device 10 has a plurality of nozzle elements distributed in the circumferential direction U, only one nozzle element 60 of which is shown by way of example and for reasons of clarity. The nozzle element 60 is shown in FIG. 1 in an illustration in section, in FIG. 3 in a view in perspective, and in FIG. 4 in a perspective illustration in section. The nozzle element 60 is fluidically coupled to the fluid duct assembly 40 at one stator lamination stack end 32 of the stator lamination stack 30 and has at least one nozzle opening 62 shaped in order to form a fluid jet 70 for cooling at least one of the winding heads 110. A fluid pump of the electric machine 100 which serves to convey the fluid 12 through the fluid duct assembly 40 is not shown further in the present case.

The fluid duct assembly 40 has a collection duct assembly 42 by which fluid 12 can be guided from a plurality of fluid ducts of the fluid duct assembly 40 which are arranged next to one another in the circumferential direction U of the stator lamination stack 10 and are designed as first longitudinally extending fluid ducts 50, 52, 54 to a supply duct 56 of the fluid duct assembly. The nozzle element 60 is introduced into a region of the supply duct 56, which is also referred to as the second longitudinally extending fluid duct, and is fixed there, for example by being press-fitted or adhesively bonded. The collection duct assembly 42 in the present case comprises a plurality of radially extending fluid ducts, only three radially extending fluid ducts 44, 46, 48 of which, converging in the direction of the supply duct 56 in an arrow shape, are shown in FIG. 2 for reasons of clarity. It should be noted that the respective stator laminations which cover the radially extending fluid ducts 44, 46, 48 when the stator lamination stack 10 is assembled are hidden in FIG. 2 such that the radially extending fluid ducts 44, 46, 48 are as it were exposed in FIG. 2. Needs-based cooling of the winding heads 110 can be achieved, for example, when, as can be seen by viewing FIGS. 1 and 2 together, three first longitudinally extending fluid ducts 50, 52, 54 are connected to the supply duct 56 via three radially extending fluid ducts 44, 46, 48 which converge, in particular converge in an arrow shape as shown in FIG. 2, i.e. for example three of the longitudinally extending fluid ducts of the fluid duct assembly 40 are generally always merged by three radially extending fluid ducts of the fluid duct assembly 40 to form one of the supply ducts of the fluid duct assembly 40.

The first longitudinally extending fluid ducts 50, 52, 54 arranged next to one another in the circumferential direction U are arranged further toward the inside in the direction of radial extent R of the stator device 10 than the supply duct 56, as can be seen in FIG. 1.

The nozzle element 60 has a nozzle element duct region 64 which traverses a plurality of the stator laminations 20, 22, 24, 26, 28 and via which a nozzle element end region 66, connected to the nozzle element duct region 64, of the nozzle element 60 can be supplied with fluid 12 from the fluid duct assembly 40, as can be seen in FIG. 1. The hemispherically formed nozzle element end region 66 is arranged outside the stator lamination stack 30 and is supported on an end side 34 of the stator lamination stack 30 at the stator lamination stack end 32. The nozzle opening 62 is arranged at the nozzle element end region 66 and fluidically connected to the nozzle element duct region 64.

Respective center axes 63, 65 of the nozzle opening 62 and of the nozzle element duct region 64 enclose an angle α between them. The center axis 63 is here associated with the nozzle opening 62 and the further center axis 65 with the nozzle element duct region 64.

### LIST OF REFERENCE SIGNS

10 stator device
12 fluid
20 stator lamination
22 stator lamination
24 stator lamination
26 stator lamination
28 stator lamination
30 stator lamination stack
32 stator lamination stack end
34 end side
40 fluid duct assembly
42 collection duct assembly
44 radially extending fluid duct
46 radially extending fluid duct
48 radially extending fluid duct
50 first longitudinally extending fluid duct
52 first longitudinally extending fluid duct
54 first longitudinally extending fluid duct
56 supply duct
60 nozzle element
62 nozzle opening
63 center axis
64 nozzle element duct region
65 center axis
66 nozzle element end region
70 fluid jet
100 electric machine
110 winding head
K motor vehicle
L direction of longitudinal extent
R direction of radial extent
U circumferential direction
α angle

1-10. (canceled)

11. A stator device for an electric machine configured to drive a motor vehicle, comprising:
a plurality of stator laminations juxtaposed in a direction of longitudinal extent of the stator device, which together form a stator lamination stack;
a fluid duct assembly that extends through the stator lamination stack in the direction of longitudinal extent and that, in order to cool winding heads of the electric machine, is configured to guide fluid in a direction of the winding heads; and
at least one nozzle element that is fluidically coupled to the fluid duct assembly at at least one stator lamination stack end of the stator lamination stack and that comprises at least one nozzle opening shaped to form a fluid jet for cooling at least one of the winding heads.

12. The stator device according to claim 11,
wherein the fluid duct assembly comprises at least one collection duct assembly by which fluid can be guided from a plurality of fluid ducts of the fluid duct assembly arranged next to one another in a circumferential direction of the stator lamination stack, to at least one supply duct of the fluid duct assembly, into which at least one supply duct the at least one nozzle element is introduced.

13. The stator device according to claim 12,
wherein the plurality of fluid ducts are arranged more toward an inside in a direction of radial extent of the stator device than the at least one supply duct.

14. The stator device according to claim 11,
wherein the at least one nozzle element comprises a nozzle element duct region that traverses the plurality of stator laminations, and via which a nozzle element end region of the at least one nozzle element, which is connected to the nozzle element duct region, is configured to be supplied with fluid from the fluid duct assembly.

15. The stator device according to claim 14,
wherein the nozzle element end region is arranged outside the stator lamination stack.

16. The stator device according to claim 14,
wherein the nozzle opening is arranged at the nozzle element end region and is fluidically connected to the nozzle element duct region.

17. The stator device according to claim 16,
wherein respective center axes of the nozzle opening and of the nozzle element duct region enclose an angle between them.

18. The stator device according to claim 14,
wherein at least a region of the nozzle element end region has a hemispherical form.

19. An electric machine for a motor vehicle, comprising:
the stator devices according to claim 11.

20. A motor vehicle comprising:
the electric machine according to claim 19.
